(19) United States
(12) Patent Application Publication
(10) Pub. No.: US 2019/0241736 A1
(43) Pub. Date: Aug. 8, 2019

(54) THERMOPLASTIC MOLDING COMPOUNDS

(71) Applicant: LANXESS Deutschland GmbH, Cologne (DE)

(72) Inventors: Jochen ENDTNER, Cologne (DE); Matthias BIENMUELLER, Krefeld (DE)

(73) Assignee: LANXESS Deutschland GmbH, Cologne (DE)

(21) Appl. No.: 16/329,876

(22) PCT Filed: Jul. 28, 2017
(86) PCT No.: PCT/EP2017/069107

§ 371 Date: Mar. 1, 2019

(30) Foreign Application Priority Data
Sep. 1, 2016 (EP) 16186756.9

(51) Int. Cl. C08L 67/02; C08K 3/013; C08K 3/34; C08K 3/04; C08K 5/3492; C08K 5/5313; C08K 5/521; C08K 3/30; C08K 5/5399; B29B 9/02; B29B 9/10; C08K 7/14; C08K 5/00

(52) U.S. Cl. CPC C08L 67/02; C08L 2203/20; C08K 3/34; C08K 3/04; C08K 5/34922; C08K 5/5313; C08K 5/521; C08K 3/30; C08K 5/5399; B29B 9/02; B29B 9/10; C08K 7/14; C08K 5/0066; C08K 2003/3045; C08L 2201/02; C08K 3/013

(57) ABSTRACT

The invention relates to compositions and thermoplastic moulding compounds producible therefrom and articles of manufacture in turn based thereupon comprising not only polyethylene terephthalate but also at least one further polyester from the group of the polyalkylene terephthalates or polycycloalkylene terephthalates, also at least one organic phosphinic salt and/or at least one organic diphosphinic salt, melem and melamine polyphosphate.

The invention relates to compositions and moulding compounds producible therefrom and articles of manufacture in turn based thereupon comprising not only polyethylene terephthalate but also at least one further polyester from the group of the polyalkylene terephthalates or polycycloalkylene terephthalates and at least one organic phosphinic salt and/or at least one organic diphosphinic salt and at least one condensed melamine derivative and at least one reaction product of a melamine derivative with phosphoric acids or condensed phosphoric acids.

### PRIOR ART

Not least because of their good electrical indices, for example with regard to dielectric strength and specific breakdown resistance, polyesters are popular materials in electronic and electrical applications. Because of the risk of fire breaking out in the vicinity of current-conducting components, materials that have been rendered flame retardant are frequently used. According to the field of use, what is being sought is not only good self-extinction, for example a UL94 V-0 classification (Underwriters Laboratories Inc. Standard of Safety, “Test for Flammability of Plastic Materials for Parts in Devices and Appliances”, p. 14 to p. 18 Northbrook 1998), but also low ignitability. For example, IEC 60335-1, for components in unattended domestic appliances within a distance of 3 mm from current-conducting components with currents >0.2 A, specifies a glow wire test according to IEC 60695-2-11 on the finished component, where there must be no appearance of flame for more than two seconds at a glow wire temperature of 750° C. Experience shows that test results on a finished component, because of the undefined geometry of finished components or else the metal contacts that impair heat flow, do not correspond directly to test results which have been conducted according to IEC 60695-2-13 on a defined round plaque at the same glow wire temperature, especially since, according to IEC 60695-2-13, a specimen is considered to have not ignited even if a flame appears for less than 5 seconds.

In order to be sure that a material in the finished component too, and irrespective of the geometry, does not show a flame with a burn time of longer than 2 seconds even at glow wire temperature 750° C., there is an increasing desire for materials which have a greater safety margin in a plaque test according to IEC 60695-2-13, meaning that there is still no ignition over and above standard requirements, even at distinctly higher glow wire temperatures than 750° C., in which context “no ignition” is not interpreted as meaning, according to IEC 60695-2-13, appearance of flame for <5 seconds, but as meaning no flame at all in the literal sense, i.e. as a burn time of 0 seconds. In order to take account of the variable thicknesses of the finished components, this should be fulfilled in the same way on test plaques having a wall thickness of at least 3 mm, and also in thin test plaques having a maximum wall thickness of 0.75 mm.

In recent times not least for ecological reasons halogen-free solutions are increasingly demanded.

On account of the often complex construction of plastics-based articles of manufacture, particularly in the field of domestic appliances, there is also a desire for materials having comparatively low shrinkage which altogether also reduces warpage and thus facilitates construction and mould configuration.

It is known from technical data sheets that for identical contents of fillers or reinforcers mixtures of polybutylene terephthalate (PBT) and polyethylene terephthalate (PET) exhibit a lower processing shrinkage than a corresponding PBT without a PET fraction. However a problem with PBT+PET blends is the risk of transesterification at temperatures above the melting point which can result in undesired side effects, for example retarded crystallization [Handbook of Thermoplastics, 2nd revised ed. 2015, Olagoke Olabisi (ed.), Kolapo Adewale (ed.), CRC Press Inc. USA, p. 331]. Yet it is not known to what extent specific additives for improving performance in the glow wire ignitability test according to IEC60695-2-13 can negatively affect transesterification.

EP 2 927 279 Al describes compositions comprising PBT, phosphinic salts, >4% by weight of a phosphazene compound and cyclic nitrogen compounds, which attain a GWIT of at least 775° C. according to IEC 60695-2-13 on plaques of different thickness. Also disclosed therein is an indication that when using PBT+PET blends warpage could be reduced, though with the proviso that the crystallization time becomes lengthier which had the disadvantage of lengthier cycle times and EP 2 927 279 A1 therefore favours compositions comprising PBT as the sole resin.

EP 1 945 708 B1 describes compositions comprising PBT, PET, a metal phosphinate which melts below 310° C. and melamine polyphosphate which at a plaque thickness of 1.5 mm in the glow wire test according to IEC60695-2-13 attain at least a GWIT of 775° C. but does not elaborate on the problem of transesterification of PBT and PET or on the glow wire performance at thinner wall thicknesses than 1.5 mm. Also, individual examples in EP 1 945 708 B1 show only a V-2 classification in the UL94 test at wall thicknesses of 0.75 mm.

The problem addressed by the present invention is accordingly that of providing compositions and moulding compounds/articles of manufacture producible therefrom based on blends of polyethylene terephthalate and at least one further polyalkylene terephthalate and/or polycycloalkylene terephthalate which are largely thermally stable toward transesterification, exhibit a V-0 classification in the UL94 test at wall thicknesses ≥0.75 mm and show no ignition in the glow wire test according to IEC60695-2-13 even at a glow wire temperature of at least 800° C. at wall thicknesses ≥0.75 mm.

No ignition in the glow wire test shall be understood to mean that there is no flame, i.e. the burn time of the flame is 0 seconds.

Stable towards transesterification is to be understood as meaning in accordance with the invention that the melting point of the highest melting blend component, measured as an endothermic peak with the DSC method more particularly described hereinbelow (differential scanning calorimetry [https://de.wikipedia.org/wiki/Dynamische Differenzkalorimetrie]), in the 2nd heating is not more than 10° C. below the melting point of the highest melting blend component in the 1st heating. A Mettler DSC 822e DSC instrument from Mettler Toledo, Greifensee, Switzerland is loaded with 10(±2)mg of a compound to be investigated and then under nitrogen heated initially from 0° C. to 280° C. at 20K/min [“1st heating”], then cooled from 280° C. to 0° C. again at −10K/min and finally heated from 0° C. to 280° C. again at 20K/min [“2nd heating”]. The sample is thus subjected over a relatively long period to high temperatures which in unstable compounds results in secondary reactions, in the case of polyalkylene terephthalate blends to transesterifications in particular. The shift in the melting peak between the 1st heating and the 2nd heating towards lower temperatures may therefore be regarded as a measure of the degree of transesterification and thus as a measure of the thermal stability of a sample, wherein a shift of less than or equal to 10° C. represents a low propensity for transesterification according to the invention while a shift of more than 10° C. represents a high degree of transesterification and thus low thermal stability.

### INVENTION

The solution to the problem and the subject-matter of the invention are provided by compositions and also moulding compounds and articles of manufacture producible therefrom comprising
A) at least one polyalkylene terephthalate distinct from polyethylene terephthalate, or polycycloalkylene terephthalate,
B) polyethylene terephthalate,
C) at least one organic phosphinic salt of formula (I) and/or at least one organic diphosphinic salt of formula (II) and/or polymers thereof,

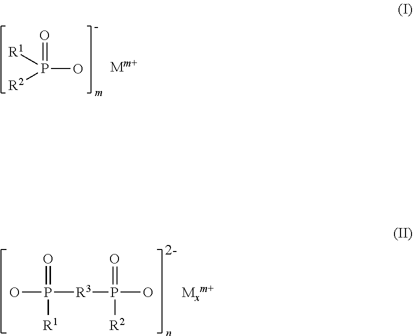

in which
R¹, R² are identical or different and stand for a linear or branched C₁-C₆-alkyl and/or for C₆-C₁₄-aryl,
   R³ stands for linear or branched Cₗ-C₁₀-alkylene, C₆-C₁₀-arylene or for C₁-C₆-alkyl-C₆-C₁₀-arylene or C₆-C₁₀-aryl-C₁-C₆-alkylene,
   M stands for aluminium, zinc or titanium,
   m stands for an integer in the range from 1 to 4;
   n stands for an integer in the range from 1 to 3 and
   x stands for 1 and 2,
wherein n, x and m in formula (II) may at the same time adopt only integer values such that the diphosphinic salt of formula (II) as a whole is uncharged,
D) at least one condensed melamine derivative and
E) at least one reaction product of a melamine derivative with phosphoric acids or condensed phosphoric acids which is distinct from component D).

It is now been found that, surprisingly, compared to the prior art, articles of manufacture based on the compositions according to the invention show very high glow wire ignitability values and flame retardancies and—despite the use of at least two different polyester components—only a low propensity for transesterification. When using a combination of component D) and component E) it is thus possible in polyester mixtures of component A) and B) that have been rendered flame-retardant by component C) to achieve both high GWIT values and simultaneously high thermal stability with regard to transesterification. If at least one of the two components D) and/or E) is missing this results in intensified transesterification of the components A) and B) with one another which is verified by relevant experiments in the examples section.

It is noted for the avoidance of doubt that the scope of the present invention encompasses all below-referenced definitions and parameters referred to in general terms or within preferred ranges in any desired combinations. Standards listed are to be understood as referring to the version in force on the filing date unless otherwise stated.

“Alkyl” in the context of the present invention refers to a straight-chain or branched saturated hydrocarbon group. In certain embodiments, an alkyl group having 1 to 6 carbon atoms is used. It can then be referred to as a “lower alkyl group”. Preferred alkyl groups are methyl (Me), ethyl (Et), propyl, in particular n-propyl and isopropyl, butyl, in particular n-butyl, isobutyl, sec-butyl, tert-butyl, pentyl groups, in particular n-pentyl, isopentyl, neopentyl, hexyl groups and the like. Similar comments apply in respect of the term “polyalkylene”.

“Aryl” in the context of the present invention denotes a monocyclic aromatic hydrocarbon ring system or a polycyclic ring system in which two or more aromatic hydrocarbon rings are fused, or at least one aromatic monocyclic hydrocarbon ring which is fused with one or more cycloalkyl and/or cycloheteroalkyl rings. In embodiments according to the invention, aryl or arylene is an aryl group having 6 to 14 carbon atoms. Preferred aryl groups having an aromatic carbocyclic ring system are phenyl, 1-naphthyl (bicyclic), 2-naphthyl (bicyclic), anthracenyl (tricyclic), phenanthrenyl (tricyclic), pentacenyl (pentacyclic) and similar groups. Other preferred aryl groups are benzodioxanyl, benzodioxolyl, chromanyl, indolinyl groups and the like. In a number of embodiments aryl groups, as described herein, may be substituted. In a number of embodiments an aryl group may have one or more substituents.

“Alkylaryl” in the context of the present invention denotes an alkyl-aryl group, the alkylaryl group being covalently bonded to the defined chemical structure via the alkyl group. One alkylaryl group preferred in accordance with the invention is the benzyl group (—CH₂—C₆H₅). Alkylaryl groups according to the present invention may optionally be substituted, i.e. either the aryl group and/or the alkyl group may be substituted. By contrast, “arylalkyl” in the context of the present invention denotes an aryl-alkyl group where the arylalkyl group is covalently bonded to the defined chemical structure via the aryl group.

The invention preferably relates to compositions and also moulding compounds and articles of manufacture producible therefrom comprising, based on 100 parts by mass of component A),
25 to 120 parts by mass of component B),
20 to 80 parts by mass of component C),
2 to 40 parts by mass of component D), and
2 - 30 parts by mass of component E).

The inventive compositions are formulated for further utilization by mixing the components A) to E) for use as reactants in at least one mixing apparatus, preferably a compounder. This affords, as intermediates, moulding compounds based on the compositions according to the invention. The compositions but also the moulding compounds and articles of manufacture producible therefrom may either be composed exclusively of components A) to E) or else may comprise, in addition to components A) to E), further components, preferably at least one of the components F) to K) described hereinbelow.

In one embodiment, the inventive compositions and also moulding compounds and articles of manufacture producible therefrom comprise, in addition to components A) to E), also F) at least one further flame retardant distinct from components C), D) and E), preferably in amounts in the range from 2 to 50 parts by mass, based on 100 parts by mass of component A).

In one embodiment, the inventive compositions and also moulding compounds and articles of manufacture producible therefrom comprise, in addition to components A) to F) or in place of F), also G) at least one metal sulfate, preferably in amounts in the range from 1 to 40 parts by mass, based on 100 parts by mass of component A).

In one embodiment, the inventive compositions and also moulding compounds and articles of manufacture producible therefrom comprise, in addition to components A) to G) or in place of F) and/or G), also H) at least one filler or reinforcer distinct from components A) to G), preferably in amounts in the range from 0.1 to 300 parts by mass, based on 100 parts by mass of component A).

In one embodiment, the inventive compositions and also moulding compounds and articles of manufacture producible therefrom comprise, in addition to components A) to H) or in place of F) and/or G) and/or H), also K) at least one further additive distinct from components C) to H), preferably in amounts in the range from 0.01 to 80 parts by mass, based on 100 parts by mass of component A).

According to the invention, components F), G), H) and K) may be present in the compositions, moulding compounds and articles of manufacture, but they may also be absent. Preferably, the following combinations of the components arise for the compositions, moulding compounds and articles of manufacture:

A), B), C), D), E);

A), B), C), D), E), F);

A), B), C), D), E), G);

A), B), C), D), E), H);

A), B), C), D), E), K);

A), B), C), D), E), F), G);

A), B), C), D), E), F), H);

A), B), C), D), E), F), K);

A), B), C), D), E), F), G), H);

A), B), C), D), E), F), G), K);

A), B), C), D), E), F), G), H), K).

The compositions according to the invention, also generally referred to in the plastics industry as moulding compounds, are obtained upon processing components A) to E) and optionally also at least one of the components F), G), H) or K) preferably as pellet material, in the form of extrudates or as powder. Preparation is effected by mixing the inventive compositions in at least one mixing apparatus, preferably a compounder, particularly preferably a corotating twin-screw extruder. The procedure of mixing of components A) to E) and optionally at least one further component F) and/or G) and/or H) and/or K) to produce compositions according to the invention in the form of powders, pellet materials or extrudates is also referred to in the plastics industry as compounding. This affords, as intermediates, moulding compounds based on the compositions according to the invention. These moulding compounds—also known as thermoplastic moulding compounds—may either be composed exclusively of components A) to E) or else may comprise, in addition to components A) to E), further components, preferably at least one of components F) and/or G) and/or H) and/or K). In a further step, the moulding compounds of the invention are then subjected as matrix material to an injection moulding or extrusion operation, preferably an injection moulding operation, in order to produce articles of manufacture according to the invention therefrom. Articles of manufacture according to the invention therefore comprise the same components A) to E) and optionally also at least one of components F), G), H) or K).

Component A)

The polyalkylene terephthalates or polycycloalkylene terephthalates distinct from polyethylene terephthalate for use as component A) in accordance with the invention may be produced by various methods, may be synthesized from a variety of building blocks, and, in a specific application scenario, alone or in combination, may be endowed with processing aids, stabilizers, polymeric alloying co-components, preferably elastomers, or else reinforcing materials, preferably mineral fillers or glass fibres, and optionally further additives to afford materials having specifically adjusted combinations of properties. Also suitable are blends with fractions of other polymers, in which case it is possible optionally for one or more compatibilizers to be employed. The properties of the polymers may be improved as and when needed by addition of elastomers.

Polyalkylene terephthalates or polycycloalkylene terephthalates preferred for use as component A) can be produced from terephthalic acid (or reactive derivatives thereof) and aliphatic or cycloaliphatic diols having 2 to 10 carbon atoms by known methods (Kunststoff-Handbuch, vol. VIII, p. 695 ff, Karl Hanser Verlag, Munich 1973).

Polyalkylene terephthalates or polycycloalkylene terephthalates preferred for use as component A) comprise at least 80 mol %, preferably at least 90 mol %, based on the dicarboxylic acid, of terephthalic acid radicals and at least 80 mol %, preferably at least 90 mol %, based on the diol component, of 1,4-cyclohexanedimethanol and/or propane-1,3-diol (in the case of polypropylene terephthalate) and/or butane-1,4-diol radicals.

Polyalkylene terephthalates or polycycloalkylene terephthalates preferred for use as component A) may as well as terephthalic acid radicals include up to 20 mol % of radicals of other aromatic dicarboxylic acids having 8 to 14 carbon atoms or radicals of aliphatic dicarboxylic acids having 4 to 12 carbon atoms, more particularly radicals of phthalic acid, isophthalic acid, naphthalene-2,6-dicarboxylic acid, 4,4′-biphenyldicarboxylic acid, succinic acid, adipic acid, sebacic acid, azelaic acid, cyclohexanediacetic acid, cyclohexanedicarboxylic acid.

Polyalkylene terephthalates or polycycloalkylene terephthalates preferred for use as component A) may as well as 1,4-cyclohexanedimethanol and/or 1,3-propanediol and/or 1,4-butanediol include up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di((3-hydroxyethoxy)benzene, 2,2-bis(4-hydroxycyclohexyl)propane, 2,4-dihydroxy-1,1,3,3-tetramethylcyclobutane, 2,2-bis(3-6-hydroxyethoxyphenyl)propane and 2,2-bis(4-hydroxypropoxyphenyl)propane.

Polyalkylene terephthalates or polycycloalkylene terephthalates particularly preferred for use as component A) are those produced solely from terephthalic acid and reactive derivatives thereof, in particular dialkyl esters thereof, and 1,4-cyclohexanedimethanol and/or 1,3-propanediol and/or 1,4-butanediol, especially preferably poly-1,4-cyclohexanedimethanol terephthalate, polyethylene terephthalate and polybutylene terephthalate and mixtures thereof.

Polyalkylene terephthalates or polycycloalkylene terephthalates preferred for use as component A) also include copolyesters produced from at least two of the abovementioned acid components and/or from at least two of the abovementioned alcohol components. Particularly preferred copolyesters are poly(ethylene glycol/butane-1,4-diol) terephthalates.

The polyalkylene terephthalates or polycycloalkylene terephthalates to be employed as component A) generally have an intrinsic viscosity in the range from 30 to 150 cm³/g, preferably in the range from 40 to 130 cm³/g, particularly preferably in the range from 50 to 100 cm³/g, measured in each case in phenol/o-dichlorobenzene (1:1 part by weight) at 25° C. The intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). The VN [ml/g] is obtained from the measurement of the solution viscosity in a capillary viscometer, for example an Ubbelohde viscometer. The solution viscosity is a measure of the average molecular weight of a plastics material. Determination is made on dissolved polymer, with various solvents (formic acid, m-cresol, tetrachloroethane, phenol, 1,2-dichlorobenzene, etc.) and concentrations being used. The viscosity number VN makes it possible to monitor the processing and performance characteristics of plastics. Thermal stressing of the polymer, ageing processes, or the action of chemicals, weather and light may be investigated by means of comparative measurements. The method is standardized for common polymers; in the context of the present invention according to DIN ISO 1628-5 for polyesters. In this regard, see also: http://de.wikipedia.org/wiki/Viskosimetrie and “http://de.wikipedia.org/wiki/Mark-Houwink-Gleichung”.

The polyalkylene terephthalates or polycycloalkylene terephthalates for use as component A) in accordance with the invention may also be used in admixture with other polyesters and/or further polymers.

The polyalkylene terephthalates or polycycloalkylene terephthalates for use as component A) may be admixed during compounding with customary additives, in particular mould-release agents, in the melt.

The person skilled in the art understands compounding to mean the plastics-industry term, synonymous with plastics processing, which describes the finishing process for plastics by admixture of additive substances (fillers, additives etc.) for specific optimization of profiles of properties. Compounding is preferably effected in extruders, particularly preferably in corotating twin-screw extruders, counterrotating twin-screw extruders, planetary gear extruders or cocompounders and comprises the process operations conveying, melting, dispersing, mixing, degassing and pressure build-up.

As component A), preference is given to using polybutylene terephthalate (PBT) [CAS No. 24968-12-5], available under the Pocan® brand from Lanxess Deutschland GmbH, Cologne.

An alternative used as component A) is preferably poly-1,4-cyclohexanedimethanol terephthalate [CAS No. 25037-99-4] as polycycloalkylene terephthalate. Component B)

The polyethylene terephthalate (PET) [CAS Nr. 25038-59-9] for use as component B) in accordance with the invention may be produced by various methods, may be synthesized from a variety of building blocks, and, in a specific application scenario, alone or in combination, may be endowed with processing aids, stabilizers, polymeric alloying co-components (for example elastomers) or else reinforcing materials (for example mineral fillers or glass fibres) and optionally further additives to afford materials having specifically adjusted combinations of properties.

PET preferred for use as component B) comprises at least 80 mol %, preferably at least 90 mol %, based on the dicarboxylic acid, of terephthalic acid radicals and at least 80 mol %, preferably at least 90 mol %, based on the diol component, of ethylene glycol radicals.

PET preferred for use as component B) may comprise, as well as terephthalic acid radicals, up to 20 mol % of radicals of other aromatic dicarboxylic acids having 8 to 14 carbon atoms or radicals of aliphatic dicarboxylic acids having 4 to 12 carbon atoms, in particular radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid, wherein isophthalic acid is preferred. Particular preference is given to an isophthalic acid content in the range from 0.1 to 10 mol %, very particularly preferably in the range from 0.5-5 mol %.

PET preferred for use as component B) may comprise in addition to ethylene glycol up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(6-hydroxyethoxy)benzene, 2,2-bis(4-hydroxycyclohexyl)propane, 2,4-dihydroxy-1,1,3,3-tetramethylcyclobutane, 2,2-bis(3-6-hydroxyethoxyphenyl)propane and 2,2-bis(4-hydroxypropoxyphenyl)propane.

It is particularly preferable to employ PET produced solely from terephthalic acid and reactive derivatives thereof, in particular dialkyl esters thereof, and ethylene glycol.

PET for use as component B) in accordance with the invention generally has an intrinsic viscosity in the range from 30 to 150 cm³/g, preferably in the range from 40 to 130 cm³/g, particularly preferably in the range from 50 to 100 cm³/g, in each case measured in phenol/o-dichlorobenzene (1:1 part by weight) at 25° C. The PET for use in accordance with the invention may also be recyclate.

Recyclates are generally understood to mean:

1) so-called post-industrial recyclate (also known as pre-consumer recyclate): this comprises production wastes from polycondensation, from compounding (e.g. off-spec material) or from processing, for example sprues in injection moulding, start-up material in injection moulding or extrusion, or offcuts of extruded sheets or films.

2) post-consumer recyclate: this comprises plastics articles which are collected and processed after use by the end user. By far the dominant articles in terms of quantity are blow-moulded PET bottles for mineral water, soft drinks and juices.

PET recyclates from recycled PET bottles preferred for use as component B) in accordance with the invention are preferably obtained by a method according to DE 103 24 098 A1, WO 2004/009315 A1 or according to WO 2007/116022 A2.

The PET for use as component B) may be admixed during compounding with customary additives, in particular mould-release agents, in the melt.

Component B) employed is particularly preferably a PET comprising 0.5-5 mol % [based on 100 mol % of diacid] of isophthalic acid.

Component C)

The organic phosphinic salts of formula (I) hereinabove and/or organic diphosphinic salts of formula (II) hereinabove and/or polymers thereof for use according to the invention as component C) are also referred to in the context of the present invention as phosphinates.

In formulae (I) or (II) M preferably stands for aluminium. In formulae (I) and (II) R¹ and R² are preferably identical or different and represent linear or branched Cₗ-C₆ alkyl and/or phenyl. R¹ and R² are particularly preferably identical or different and represent methyl, ethyl, n-propyl, isopropyl, n-butyl, tert-butyl, n-pentyl and/or phenyl.

R³ in formula (II) preferably represents methylene, ethylene, N-propylene, isopropylene, n-butylene, tert-butylene, n-pentylene, n-octylene, n-dodecylene, phenylene, naphthylene, methylphenylene, ethylphenylene, tert-butylphenylene, methylnaphthylene, ethylnaphthylene, tert-butylnaphthylene, phenylmethylene, phenylethylene, phenylpropylene or phenylbutylene. R³ particularly preferably represents phenylene or naphthylene. Suitable phosphinates are described in WO-A 97/39053, the content of which in relation to the phosphinates is encompassed by the present application. Particularly preferred phosphinates in the context of the present invention are aluminium and zinc salts of dimethylphosphinate, of ethylmethylphosphinate, of diethylphosphinate and of methyl-n-propylphosphinate and also mixtures thereof.

m in formula (I) preferably stands for 2 and 3, particularly preferably for 3.

n in formula (II) preferably stands for 1 and 3, particularly preferably for 3.

x in formula (II) preferably stands for 1 and 2, particularly preferably for 2.

Component C) is very particularly preferably a non-meltable metal phosphinate, i.e. the metal phosphinate decomposes before reaching its melting point.

Especially preferably employed as component C) is aluminium tris(diethylphosphinate) [CAS No. 225789-38-8], which is supplied, for example, by Clariant International Ltd. Muttenz, Switzerland under the Exolit® OP1230 or Exolit® OP1240 trade name.

Component D)

Employed as component D) according to the invention is at least one condensed melamine derivative. Preferred condensation products of melamine are melam [CAS No. 3576-88-3], melem [CAS No. 1502-47-2] or melon [CAS No. 32518-77-7], and mixtures thereof.

Production is possible, according to https://de.wikipedia.org/wiki/Melem_(Verbindung), for example by condensation of cyanamide, ammonium dicyanamide, dicyandiamide or melamine, synthesis proceeding over several stages. Dicyandiamide is first formed from cyanamide or ammonium dicyanamide and is then cyclized to give melamine. Condensation of melamine, with release of ammonia, leads directly or via the intermediate compound melam to the target compound.

It is particularly preferable in accordance with the invention to use melem as component D), melem qualities having a melamine content of less than 1.0% by weight being very particularly preferred and the content of melamine being determined via NIR FT-IR.

Melem for use in accordance with the invention is available, for example, as Delacal® NFR from Delamin Ltd., Derby, UK.

Component E)

As component E) for use according to the invention the compositions and moulding compounds/articles of manufacture producible therefrom comprise at least one reaction product of a melamine derivative with phosphoric acids or condensed phosphoric acids or mixtures thereof which is distinct from component D).

Melamine derivatives preferred for use in component E) are melamine, condensation products of melamine, in particular melem, melam oder melon, and derivatives of these compounds, in particular their nitrogen-substituted species.

Phosphoric acids/condensed phosphoric acids for use in component E) in the context of the invention include in particular phosphoric acid, diphosphoric acid, metaphosphoric acid and polyphosphoric acid.

Preferred reaction products of melamine derivatives with phosphoric acids or condensed phosphoric acid for use as component E) are dimelamine phosphate, dimelamine pyrophosphate, melamine phosphate, melamine pyrophosphate, melamine polyphosphate, melam polyphosphate, melon polyphosphate and melem polyphosphate such as are described in WO-A 98/39306 for example. It is very particularly preferable when component E) is melamine polyphosphate. Melamine polyphosphate is commercially available in a very wide variety of product qualities. Examples thereof include Melapur® 200/70 (BASF, Ludwigshafen, Germany) and Budit® 3141 (Budenheim, Budenheim, Germany).

Component F)

The further flame retardants for use in a preferred embodiment of the inventive compositions and moulding compounds/articles of manufacture producible therefrom as component F) are preferably halogen-free.

It is preferable when nitrogen-containing flame retardants are employed as component F). Among the nitrogen-containing flame retardants distinct from component D) and E) for use as component F), preference is given to employing reaction products of melamine with acids, very particular preference being given to melamine cyanurate and/or melamine-intercalated aluminium, zinc or magnesium salts of condensed phosphates, as described in WO2012/025362 A1. Especially preferred are melamine cyanurate, bismelamine zincodiphosphate (EP 2 609 173 A1) and/or bismelamine aluminotriphosphate (EP 2 609 173 A1), melamine cyanurate being especially particularly preferred. An example thereof is, inter alia, Melapur® MC25 from BASF, Ludwigshafen, Germany. Further preferred nitrogen-containing flame retardants distinct from components D) and E) for use as component F) are the reaction products of trichlorotriazine, piperazine and morpholine as per CAS No. 1078142-02-5, in particular MCA PPM Triazin HF from MCA Technologies GmbH, Biel-Benken, Switzerland.

It is preferable when phosphorus-containing flame retardants too are employed as component F). Among the phosphorus-containing flame retardants distinct from component C) and E) for use as component F), preference is given to employing phosphorus compounds from the group of the inorganic metal phosphinates, in particular aluminium phosphinate and zinc phosphinate, of the mono- and oligomeric phosphoric and phosphonic esters, in particular triphenyl phosphate (TPP), resorcinol bis(diphenylphosphate) (RDP), bisphenol A bis(diphenylphosphate) (BDP) including oligomers, polyphosphonates, in particular bisphenol A-diphenyl methylphosphonate copolymers, for example Nofia™ HM1100 [CAS No. 68664-06-2] from FRX Polymers, Chelmsford, USA), and also derivatives of the 9,10-dihydro-9-oxa-10-phosphaphenanthrene 10-oxides (DOPO derivatives), phosphonate amines, metal phosphonates, in particular aluminium phosphonate and zinc phosphonate, phosphine oxides and phosphazenes.

Phenoxyphosphazene oligomers are particularly preferred. The phosphazenes and the production thereof are described for example in EP-A 728 811, DE-A 1961668 and WO-A 97/40092. Especially very particularly preferably employed as component F) are cyclic phenoxyphosphazenes such as 2,2,4,4,6,6-hexahydro-2,2,4,4,6,6-hexaphenoxytriazatriphosphorines [CAS No. 1184-10-7] and/or those as obtainable, for example, from Fushimi Pharmaceutical Co. Ltd, Kagawa, Japan under the Rabitle® FP110 name [CAS No. 1203646-63-2].

Other flame retardants or flame retardant synergists not specifically mentioned here may also be employed as component F). These also include purely inorganic phosphorus compounds distinct from component E), in particular red phosphorus or boron phosphate hydrate. It is also possible to employ mineral flame retardant additives or salts of aliphatic and aromatic sulfonic acids, in particular metal salts of 1-perfluorobutanesulfonic acid. Also suitable are flame retardant synergists from the group of the oxygen-, nitrogen- or sulfur-containing metal compounds distinct from component G) in which metal is zinc, molybdenum, calcium, titanium, magnesium or boron, preferably zinc oxide, zinc borate, zinc stannate, zinc hydroxystannate, zinc sulfide, molybdenum oxide, magnesium carbonate, calcium carbonate, calcium oxide, titanium nitride, boron nitride, magnesium nitride, zinc nitride, calcium borate, magnesium borate or mixtures thereof.

Further flame retardant additives that are preferred for use as component F) and are suitable are char formers, particularly preferably poly(2,6-diphenyl-1,4-phenyl) ether, in particular poly(2,6-dimethyl-1,4-phenylene) ether [CAS No. 25134-01-4], phenol-formaldehyde resins, polycarbonates, polyimides, polysulfones, polyethersulfones or polyether ketones.

The flame retardants for use as component F) may be added to component A) and/or component B) in pure form and also via masterbatches or compactates.

Component G)

Employed as component G) is at least one metal sulfate, wherein the metal is selected from magnesium, calcium, barium and zinc. It is preferable to employ magnesium or barium, particularly preferably barium.

Barium sulfate [CAS No. 7727-43-7] may be used in the form of naturally occurring baryte or in the form of barium sulfate produced synthetically by known industrial methods. A customary method of production for barium sulfate taught in http://de.wikipedia.org/wiki/Bariumsulfat for example is the precipitation of barium sulfide or barium chloride with sodium sulfate. The median particle size [d50] here is preferably in the range from 0.1 to 50 μm, particularly preferably in the range from 0.5 to 10 μm and very particularly preferably in the range from 0.6 to 2 μm. The barium sulfate here may be untreated or may have been endowed with inorganic and/or organic surface treatments. Examples of inorganic or organic surface treatments and also methods for application thereof to the surface are taught in WO2008/023074 A1, for example. Suitable synthetic barium sulfates are available, for example, from Sachtleben Chemie GmbH, Duisburg, Germany under the trade names Blanc fixe F and Blanc Fixe Super F. The underlying standard is ISO 13317-3.

Further suitable barium sulfate qualities are, for example, Albasoft® 90 and/or Albasoft® 100 from Deutsche Baryt Industrie Dr. Rudolf Alberti GmbH&Co. KG, Bad Lauterberg im Harz, Germany

Component H)

As component H) the compositions and also moulding compounds and articles of manufacture producible therefrom may comprise at least one filler or reinforcer. However, a mixture of two or more different fillers and/or reinforcers is also preferred.

It is preferable to employ at least one filler and/or reinforcer from the group of mica, silicate, quartz, in particular quartz flour, titanium dioxide, wollastonite, nepheline syenite, kaolin, amorphous silicas, magnesium carbonate, chalk, feldspar, glass fibres, glass beads, glass flour and/or fibrous fillers and/or reinforcers based on carbon fibres as component H).

It is preferable to employ mineral particulate fillers based on mica, silicate, quartz, wollastonite, kaolin, amorphous silicas, magnesium carbonate, chalk or feldspar. It is particularly preferable to further also employ acicular mineral fillers as an additive. Acicular mineral reinforcers, also known as fillers, are understood in accordance with the invention to comprise a mineral filler having strongly pronounced acicular character. The mineral preferably has a length:diameter ratio in the range from 2:1 to 35:1, particularly preferably in the range from 3:1 to 19:1, most preferably in the range from 4:1 to 12:1.

The median particle size d50 of the acicular minerals for use as component H) in accordance with the invention is preferably less than 20 μm, particularly preferably less than 15 μm, especially preferably less than 10 μm.

As a consequence of processing to afford the moulding compound or to afford an article of manufacture, all fillers and/or reinforcers for use as component H) may have a smaller d97 or d50 value in said moulding compounds or articles of manufacture than the originally employed fillers and/or reinforcers and/or glass fibres. With regard to the d50 and d97 values in this application, the determination thereof and the meaning thereof, reference is made to Chemie Ingenieur Technik (72) p. 273-276, 3/2000, Wiley-VCH Verlags GmbH, Weinheim, 2000, according to which the d50 is that particle size below which 50% of the amount of particles lie (median value) and the d97 is that particle size below which 97% of the amount of particles lie.

The reported values for particle size distribution or particle sizes in the context of the present invention refer to so-called area-based particle sizes, before incorporation into the thermoplastic moulding compound in each case. Particle size determination is performed by laser diffractometry, see C. M. Keck, Moderne Pharmazeutische Technologie 2009, Freie Universitat Berlin, Chapter 3.1. or QUANTACHROME PARTIKELWELT NO 6, June 2007, pages 1 to 16. The underlying standard is ISO 13317-3.

The fillers and reinforcers may be employed individually or as a mixture of two or more different fillers and/or reinforcers.

The filler and/or reinforcer for use as component H) may in a preferred embodiment be surface-modified, particularly preferably with an adhesion promoter or adhesion promoter system, especially preferably an epoxide-based one. However, pretreatment is not absolutely necessary.

In a particularly preferred embodiment, glass fibres are used as component H). According to “http://de.wikipedia.org/wiki/Faser-Kunststoff-Verbund”, a distinction is made between chopped fibres, also known as short fibres, having a length in the range from 0.1 to 1 mm, long fibres having a length in the range from 1 to 50 mm and continuous fibres having a length L>50 mm. Short fibres are used in injection moulding technology and can be processed directly by means of an extruder. Long fibres can likewise still be processed in extruders. Said fibres are widely used in fibre spraying. Long fibres are frequently added to thermosets as a filler. Continuous fibres are used in the form of rovings or fabric in fibre-reinforced plastics. Articles of manufacture comprising continuous fibres achieve the highest stiffness and strength values. Also available are ground glass fibres, the length of these after grinding typically being in the range from 70 to 200 μm.

It is preferable in accordance with the invention to employ as component H) chopped long glass fibres having an initial length in the range from 1 to 50 mm, particularly preferably in the range from 1 to 10 mm, very particularly preferably in the range from 2 to 7 mm. Initial length refers to the average length of the glass fibres as present prior to compounding of the composition(s) according to the invention to afford a moulding compound. The glass fibres preferred for use as component H) as a consequence of processing, in particular compounding, to afford the moulding compound or to afford the article of manufacture may in the moulding compound or in the article of manufacture have a d97 and/or d50 smaller than the originally employed glass fibres. Thus, the arithmetic mean of the glass fibre length after processing is frequently only in the range from 150 μm to 300 μm.

The glass fibre length and glass fibre length distribution are determined in the context of the present invention, in the case of processed glass fibres, analogously to ISO 22314, which first stipulates ashing of the samples at 625° C. Subsequently, the ash is placed onto a microscope slide covered with demineralized water in a suitable crystallizing dish, and the ash is distributed in an ultrasound bath without action of mechanical forces. The next step involves drying in an oven at 130° C., followed by the determination of the glass fibre length with the aid of light microscopy images. For this purpose, at least 100 glass fibres are measured from three images, and so a total of 300 glass fibres are used to ascertain the length. The glass fibre length either can be calculated as the arithmetic mean I, according to the equation

$${l}_{n} = \frac{1}{n} \cdot {\sum }_{i}^{n} {l}_{i}$$

where lᵢ=length of the ith fibre and n=number of fibres measured, and represented appropriately as a histogram, or else, in the case of an assumed normal distribution of the measured glass fibre lengths l, it can be determined by means of the Gaussian function in accordance with the equation

$$f ( l ) = \frac{1}{\sqrt{2 π} \cdot σ} \cdot {e}^{- \frac{1}{2} \cdot {( \frac{l - {l}_{c}}{σ} )}^{2}}$$

In this equation, l_{c} and σ are specific parameters of the normal distribution: k is the mean and σ is the standard deviation (see: M. SchoBig, Schadigungsmechanismen in faserverstarkten Kunststoffen, 1, 2011, Vieweg and Teubner Verlag, page 35, ISBN 978-3-8348-1483-8). Glass fibres not incorporated into a polymer matrix are analysed with respect to their lengths by the above methods, but without processing by ashing and separation from the ash.

The glass fibres [CAS No. 65997-17-3] preferred for use as component H) in accordance with the invention preferably have a fibre diameter in the range from 7 to 18 μm, particularly preferably in the range from 9 to 15 μm, which can be determined by at least one facility available to the skilled person, in particular by computer x-ray microtomography analogously to “Quantitative Messung von Faserlangen und-verteilung in faserverstarkten Kunststoffteilen mittels μ-Röntgen-Computertomographie” [Quantitative measurement of fibre lengths and fibre distribution in fibre-reinforced plastic components by computer x-ray microtomography], J. KASTNER, et al. DGZfP-Jahrestagung 2007—paper 47. The glass fibres preferred for use as component H) are preferably added as continuous fibres or as chopped or ground glass fibres.

The fillers and/or reinforcers for use as component H), in particular glass fibres, are preferably endowed with a suitable size system and an adhesion promoter or adhesion promoter system, particularly preferably a silane-based one.

Very particularly preferred silane-based adhesion promoters for pretreatment are silane compounds of general formula (III)

(X—(CH₂)_{q})ₖ—Si—(O—CrH₂ᵣ₊₁)₄_{^{−}}ₖ (III)

in which the substituents are defined as follows:

X: NH₂—, HO—,

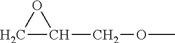

q: an integer from 2 to 10, preferably from 3 to 4,

r: an integer from 1 to 5, preferably from 1 to 2,

k: an integer from 1 to 3, preferably 1.

Especially preferred adhesion promoters are silane compounds from the group of aminopropyltrimethoxysilane, aminobutyltrimethoxysilane, aminopropyltriethoxysilane, aminobutyltriethoxysilane and the corresponding silanes comprising a glycidyl group as the substituent X.

For the endowment of the glass fibres the silane compounds are preferably employed for surface coating in amounts in the range from 0.05% to 2% by weight, particularly preferably in the range from 0.25% to 1.5% by weight and in particular in the range from 0.5% to 1% by weight, based on 100% by weight of the filler and/or reinforcer, in particular the glass fibres.

Component K)

Preferred further additives for use as component K) include lubricants and mould-release agents, UV stabilizers, colourants, chain-extension additives, antioxidants, plasticizers, flow assistants, heat stabilizers, antioxidants, gamma-ray stabilizers, hydrolysis stabilizers, elastomer modifiers, antistats, emulsifiers, nucleating agents, processing aids, anti-drip agents and, if required for the application, also halogen-containing flame retardants and their synergists.

The additives can be used alone or in admixture/in the form of masterbatches.

Preferred lubricants and mould-release agents are those selected from the group of the long-chain fatty acids, the salts of long-chain fatty acids, the ester derivatives of long-chain fatty acids, and also montan waxes.

Preferred long-chain fatty acids are stearic acid or behenic acid. Preferred salts of the long-chain fatty acids are calcium or zinc stearate. Preferred ester derivatives of long-chain fatty acids are those based on pentaerythritol, more particularly C₁₆-C₁₈ fatty acid esters of pentaerythritol [CAS No. 68604-44-4] or [CAS No. 85116-93-4].

Montan waxes in the context of the present invention are mixtures of straight-chain saturated carboxylic acids having chain lengths of from 28 to 32 carbon atoms. It is particularly preferable in accordance with the invention to employ lubricants and/or mould-release agents from the group of esters of saturated or unsaturated aliphatic carboxylic acids having 8 to 40 carbon atoms with aliphatic saturated alcohols having 2 to 40 carbon atoms and metal salts of saturated or unsaturated aliphatic carboxylic acids having 8 to 40 carbon atoms, wherein pentaerythritol tetrastearate, calcium stearate [CAS No. 1592-23-0] and/or ethylene glycol dimontanate, here in particular Licowax® E [CAS No. 74388-22-0] from Clariant, Muttenz, Basle, are very particularly preferred and pentaerythritol tetrastearate [CAS No. 115-83-3], for example available as Loxiol® P861 from Emery Oleochemicals GmbH, Dusseldorf, Germany, is especially very particularly preferred.

UV stabilizers used with preference are substituted resorcinols, salicylates, benzotriazoles, triazine derivatives or benzophenones.

Colourants used with preference are organic pigments, preferably phthalocyanines, quinacridones, perylenes and dyes, preferably nigrosin or anthraquinones, and also inorganic pigments, especially titanium dioxide (if not already used as filler), ultramarine blue, iron oxide, zinc sulfide or carbon black.

Suitable as the titanium dioxide preferred for use as pigment according to the invention are titanium dioxide pigments whose parent oxides can be produced by the sulfate (SP) or chloride (CP) process and have an anatase and/or rutile structure, preferably a rutile structure. The parent oxide does not have to be stabilized, but a specific stabilization is preferred: in the CP parent oxide by an Al doping of 0.3-3.0% by weight (calculated as Al₂O₃) and an oxygen excess in the gas phase in the oxidation of the titanium tetrachloride to form titanium dioxide of at least 2%; in the case of the SP parent oxide by doping with, for example, Al, Sb, Nb or Zn. Particular preference is given to “light” stabilization with Al, or in the case of higher amounts of Al doping to compensation with antimony. It is known that when using titanium dioxide as white pigment in paints and coatings, plastics materials etc. unwanted photocatalytic reactions caused by UV absorption lead to decomposition of the pigmented material. This involves absorption of light in the near ultraviolet range by titanium dioxide pigments, forming electron-hole pairs, which produce highly reactive free radicals on the titanium dioxide surface. The free radicals formed result in binder decomposition in organic media. With preference in accordance with the invention, the photoactivity of the titanium dioxide is lowered by inorganic aftertreatment thereof, particularly preferably with oxides of Si and/or Al and/or Zr and/or through the use of Sn compounds.

It is preferable when the surface of titanium dioxide pigment has a covering of amorphous precipitated oxide hydrates of the compounds SiO₂ and/or Al₂O₃ and/or zirconium oxide. The Al₂O₃ shell facilitates pigment dispersion into the polymer matrix; the SiO₂ shell makes it more difficult for charge exchange to take place at the pigment surface, and so prevents polymer degradation.

In accordance with the invention the titanium dioxide is preferably provided with hydrophilic and/or hydrophobic organic coatings, in particular with siloxanes or polyalcohols.

Titanium dioxide [CAS No. 13463-67-7] preferred for use in accordance with the invention as a colourant of component K) preferably has a median particle size d50 in the range from 90 nm to 2000 nm, particularly preferably in the range from 200 nm to 800 nm. The median particle size d50 is the value determined from the particle size distribution at which 50% by weight of the particles have an equivalent sphere diameter smaller than this d50 value. The underlying standard is ISO 13317-3.

The reported values for particle size distribution and average particle size for titanium dioxide are based on so-called area-based particle sizes, before incorporation into the thermoplastic moulding compound in each case. Particle size determination is performed in accordance with the invention by laser diffractometry, see C. M. Keck, Moderne Pharmazeutische Technologie 2009, Freie Universitat Berlin, Chapter 3.1. or QUANTACHROME PARTIKELWELT NO 6, June 2007, pages 1 to 16.

Examples of commercially available titanium dioxide include Kronos® 2230, Kronos® 2233, Kronos® 2225 and Kronos® v1p7000 from Kronos, Dallas, USA.

According to the invention the titanium dioxide preferred for use as pigment is preferably employed in amounts in the range from 0.1 to 60 parts by mass, particularly preferably in amounts in the range from 1 to 35 parts by mass, very particularly preferably in amounts in the range from 2 to 20 parts by mass, in each case based on 100 parts by mass of component A).

As component K), di- or polyfunctional branching or chain-extending additives containing at least two and not more than 15 branching or chain-extending functional groups per molecule may preferably be employed. Suitable branching or chain-extending additives include low molecular weight or oligomeric compounds which have at least two and not more than 15 branching or chain-extending functional groups per molecule, and which are able to react with primary and/or secondary amino groups, and/or amide groups and/or carboxylic acid groups. Chain-extending functional groups are preferably isocyanates, alcohols, blocked isocyanates, epoxides, maleic anhydride, oxazolines, oxazines, oxazolones.

Especially preferred di- or polyfunctional branching or chain-extending additives are diepoxides based on diglycidyl ethers (bisphenol and epichlorohydrin), based on amine epoxy resin (aniline and epichlorohydrin), based on diglycidyl ester (cycloaliphatic dicarboxylic acids and epichlorohydrin), separately or in mixtures, and also 2,2-bis[p-hydroxyphenyl]propane diglycidyl ether, bis[p-(N-methyl-N-2,3-epoxypropylamino)phenyl]methane and epoxidized fatty acid esters of glycerol comprising at least two and no more than 15 epoxy groups per molecule.

Particularly preferred di- or polyfunctional branching or chain-extending additives are glycidyl ethers, very particularly preferably bisphenol A diglycidyl ether [CAS No. 98460-24-3] or epoxidized fatty acid esters of glycerol, and also very particularly preferably epoxidized soybean oil [CAS No. 8013-07-8].

Also particularly preferably suitable for branching/chain extension are:

1. Poly- or oligoglycidyl or poly(8-methylglycidyl) ethers, obtainable by reaction of a compound comprising at least two free alcoholic hydroxyl groups and/or phenolic hydroxyl groups and a suitably substituted epichlorohydrin under alkaline conditions, or in the presence of an acidic catalyst with subsequent alkali treatment.

Poly- or oligoglycidyl or poly(l3-methylglycidyl) ethers preferably derive from acyclic alcohols, in particular ethylene glycol, diethylene glycol and higher poly(oxyethylene) glycols, propane-1,2-diol, poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol, or from polyepichlorohydrins.

However, said ethers also preferably derive from cycloaliphatic alcohols, in particular 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene, or they comprise aromatic nuclei, in particular N,N-bis(2-hydroxyethyl)aniline or p,p′-bis(2-hydroxyethylamino)diphenylmethane.

The epoxy compounds may preferably also derive from monocyclic phenols, in particular from resorcinol or hydroquinone; or are based on polycyclic phenols, in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulfone or on condensation products of phenols with formaldehyde obtained under acidic conditions, in particular phenol novolacs.

2. Poly- or oligo(N-glycidyl) compounds further obtainable by dehydrochlorination of the reaction products of epichlorohydrin with amines comprising at least two amino hydrogen atoms. These amines are preferably aniline, toluidine, n-butylamine, bis(4-aminophenyl)methane, m-xylylenediamine or bis(4-methylaminophenyl)methane, or else N,N,O-triglycidyl-m-aminophenyl or N,N,O-triglycidyl-p-aminophenol.

However the poly(N-glycidyl) compounds also preferably include N,N′-diglycidyl derivatives of cycloalkylene ureas, particularly preferably ethylene urea or 1,3-propylene urea, and N,N′-diglycidyl derivatives of hydantoins, in particular 5,5-dimethylhydantoin.

3. Poly- or oligo(S-glycidyl) compounds, in particular di-S-glycidyl derivatives deriving from dithiols, preferably ethane-1,2-dithiol or bis(4-mercaptomethylphenyl) ether.

4. Epoxidized fatty acid esters of glycerol, in particular epoxidized vegetable oils. Said esters are obtained by epoxidation of the reactive olefin groups of triglycerides of unsaturated fatty acids. Epoxidized fatty acid esters of glycerol may be produced from unsaturated fatty acid esters of glycerol, preferably from vegetable oils, and organic peroxycarboxylic acids (Prilezhaev reaction). Methods of producing epoxidized vegetable oils are described, for example, in Smith, March, March's Advanced Organic Chemistry (5th edition, Wiley-Interscience, New York, 2001). Preferred epoxidized fatty acid esters of glycerol are vegetable oils. An epoxidized fatty acid ester of glycerol particularly preferred in accordance with the invention is epoxidized soybean oil [CAS No. 8013-07-8].

5. Glycidyl-methacrylate-modified styrene-acrylate polymers obtainable by polymerization of styrene, glycidyl methacrylate and acrylic acid and/or methacrylic acid.

Plasticizers preferred for use as component K) are dioctyl phthalate, dibenzyl phthalate, butyl benzyl phthalate, hydrocarbon oils or N-(n-butyl)benzenesulfonamide.

Flow assistants preferred for use as component K) are copolymers of at least one α-olefin with at least one methacrylic ester or acrylic ester of an aliphatic alcohol. Particularly preferred here are copolymers where the a-olefin is constructed from ethene and/or propene and the methacrylic ester or acrylic ester comprises as its alcohol component linear or branched alkyl groups having 6 to 20 C atoms. Very particular preference is given to 2-ethylhexyl acrylate. Copolymers suitable as flow assistants in accordance with the invention feature low molecular weight in addition to the composition. Accordingly, preference is given especially to copolymers having an MFI measured at 190° C. under a load of 2.16 kg of at least 100 g/10 min, preferably of at least 150 g/10 min, particularly preferably of at least 300 g/10 min. The MFI, melt flow index, serves to characterize the flow of a melt of a thermoplastic and is subject to the standards ISO 1133 or ASTM D 1238. The MFI, and all figures relating to the MFI in the context of the present invention, relate or were measured or determined in a standard manner according to ISO 1133 at 190° C. with a test weight of 2.16 kg. Copolymers of an α-olefin and an acrylic ester of an aliphatic alcohol are preferred in accordance with the invention. A copolymer of only ethene and 2-ethylhexyl acrylate is particularly preferred in accordance with the invention.

Elastomer modifiers preferred for use as component K) comprise inter alia one or more graft polymers of
K.1 5% to 95% by weight, preferably 30% to 90% by weight, of at least one vinyl monomer on
K.2 95% to 5% by weight, preferably 70% to 10% by weight, of one or more graft substrates having glass transition temperatures <10° C., preferably <0° C., particularly preferably <−20° C.

The graft substrate K.2 generally has a median particle size (d50) in the range from 0.05 to 10 μm, preferably in the range from 0.1 to 5 μm, particularly preferably in the range from 0.2 to 1 μm.

Monomers K.1 are preferably mixtures of
K.1.1 50% to 99% by weight of vinylaromatics and/or ring-substituted vinylaromatics, in particular styrene, α-methylstyrene, p-methylstyrene, p-chlorostyrene, and/or (C₁-C₈)-alkyl methacrylates, in particular methyl methacrylate, ethyl methacrylate, and
K.1.2 1% to 50% by weight of vinyl cyanides, in particular unsaturated nitriles such as acrylonitrile and methacrylonitrile, and/or (C₁-C₈)-alkyl (meth)acrylates, in particular methyl methacrylate, glycidyl methacrylate, n-butyl acrylate, t-butyl acrylate, and/or derivatives, in particular anhydrides and imides of unsaturated carboxylic acids, in particular maleic anhydride or N-phenylmaleimide.

Preferred monomers K.1.1 are selected from at least one of the monomers styrene, α-methylstyrene and methyl methacrylate; preferred monomers K.1.2 are selected from at least one of the monomers acrylonitrile, maleic anhydride, glycidyl methacrylate and methyl methacrylate.

Particularly preferred monomers are K.1.1 styrene and K.1.2 acrylonitrile.

Graft substrates K.2 suitable for the graft polymers to be employed in the elastomer modifiers are, for example, diene rubbers, EPDM rubbers, i.e. those based on ethylene/propylene and optionally diene, also acrylate, polyurethane, silicone, chloroprene and ethylene/vinyl acetate rubbers. EPDM stands for ethylene-propylene-diene rubber.

Preferred graft substrates K.2 are diene rubbers, in particular based on butadiene, isoprene etc., or mixtures of diene rubbers or copolymers of diene rubbers or mixtures thereof with further copolymerizable monomers, in particular as per K.1.1 and K.1.2, with the proviso that the glass transition temperature of component K.2 is <10° C., preferably <0° C., particularly preferably <−10° C.

Particularly preferred graft substrates K.2 are ABS polymers (emulsion, bulk and suspension ABS), wherein ABS stands for acrylonitrile-butadiene-styrene, as described, for example, in DE-A 2 035 390 or in DE-A 2 248 242 or in Ullmann, Enzyklopadie der Technischen Chemie, vol 19 (1980), p. 280 ff.

The elastomer modifiers/graft polymers are produced by free-radical polymerization, preferably by emulsion, suspension, solution or bulk polymerization, in particular by emulsion or bulk polymerization.

Particularly suitable graft rubbers also include ABS polymers, which are produced by redox initiation with an initiator system composed of organic hydroperoxide and ascorbic acid according to U.S. Pat. No. 4,937,285.

Since, as is well known, the graft monomers are not necessarily fully grafted onto the graft substrate in the grafting reaction, according to the invention “graft polymers” is to be understood as also meaning products produced by (co)polymerization of the graft monomers in the presence of the graft substrate and coobtained in the workup.

Likewise suitable acrylate rubbers are based on graft substrates K.2 which are preferably polymers of alkyl acrylates, optionally with up to 40% by weight, based on K.2, of other polymerizable, ethylenically unsaturated monomers. The preferred polymerizable acrylic esters include C₁-C₈-alkyl esters, preferably methyl, ethyl, butyl, n-octyl and 2-ethylhexyl esters; haloalkyl esters, preferably halo-C₁-C₈-alkyl esters, preferably chloroethyl acrylate, glycidyl esters, and mixtures of these monomers. Particularly preferred in this context are graft polymers having butyl acrylate as the core and methyl methacrylates as the shell, in particular Paraloid® EXL2300, Dow Corning Corporation, Midland Mich., USA.

Further preferably suitable graft substrates according to K.2 are silicone rubbers having graft-active sites, as are described in DE-A 3 704 657, DE-A 3 704 655, DE-A 3 631 540 and DE-A 3 631 539.

Preferred graft polymers comprising a silicone fraction are those comprising methyl methacrylate or styrene-acrylonitrile as the shell and a silicone/acrylate graft as the core. Employable graft polymers having styrene-acrylonitrile as the shell include Metablen® SRK200 for example. Employable graft polymers having methyl methacrylate as the shell include Metablen® S2001, Metablen® S2030 and/or Metablen® SX-005, for example. It is particularly preferable to employ Metablen® S2001. The products having the trade name Metablen® are available from Mitsubishi Rayon Co., Ltd., Tokyo, Japan.

Crosslinking may be achieved by copolymerizing monomers having more than one polymerizable double bond. Preferred examples of crosslinking monomers are esters of unsaturated monocarboxylic acids having 3 to 8 carbon atoms and unsaturated monohydric alcohols having 3 to 12 carbon atoms or of saturated polyols having 2 to 4 OH groups and 2 to 20 carbon atoms, preferably ethylene glycol dimethacrylate, allyl methacrylate; polyunsaturated heterocyclic compounds, preferably trivinyl cyanurate and triallyl cyanurate; polyfunctional vinyl compounds, preferably di- and trivinylbenzenes, but also triallyl phosphate and diallyl phthalate.

Preferred crosslinking monomers are allyl methacrylate, ethylene glycol dimethacrylate, diallyl phthalate and heterocyclic compounds having at least 3 ethylenically unsaturated groups.

Particularly preferred crosslinking monomers are the cyclic monomers triallyl cyanurate, triallyl isocyanurate, triacryloylhexahydro-s-triazine, triallylbenzenes. The amount of the crosslinked monomers is preferably 0.02% to 5% by weight, in particular 0.05% to 2% by weight, based on 100% by weight of the graft substrate K.2.

For cyclic crosslinking monomers having at least 3 ethylenically unsaturated groups, it is advantageous to restrict the amount to below 1% by weight, based on 100% by weight of the graft substrate K.2.

Preferred “other” polymerizable, ethylenically unsaturated monomers which, in addition to the acrylic esters, may optionally be used to produce the graft substrate K.2 are acrylonitrile, styrene, α-methylstyrene, acrylamides, vinyl C₁-C₆-alkyl ethers, methyl methacrylate, glycidyl methacrylate, butadiene. Preferred acrylate rubbers as graft substrate K.2 are emulsion polymers having a gel content of at least 60% by weight.

As well as elastomer modifiers based on graft polymers, it is likewise possible to use elastomer modifiers which are not based on graft polymers and have glass transition temperatures of <10° C., preferably <0° C., particularly preferably <−20° C. These preferably include elastomers having a block copolymer structure and additionally thermoplastically meltable elastomers, in particular EPM, EPDM and/or SEBS rubbers (EPM=ethylene-propylene copolymer, EPDM=ethylene-propylene-diene rubber and SEBS=styrene-ethene-butene-styrene copolymer).

Heat stabilizers preferred for use as component K) are selected from the group of sulfur-containing stabilizers, especially sulfides, dialkylthiocarbamates or thiodipropionic acids, and also those selected from the group of the iron salts and the copper salts, in the latter case especially copper(I) iodide, being used preferably in combination with potassium iodide and/or sodium hypophosphite NaH₂PO₂, and also sterically hindered amines, especially tetramethylpiperidine derivatives, aromatic secondary amines, especially diphenylamines, hydroquinones, substituted resorcinols, salicylates, benzotriazoles and benzophenones, and also sterically hindered phenols and aliphatically or aromatically substituted phosphites, and also differently substituted representatives of these groups.

Among the sterically hindered phenols preference is given to employing those having at least one 3-tert-butyl-4-hydroxy-5-methylphenyl building block and/or at least one 3,5-di(tert-butyl-4-hydroxyphenyl) building block, particular preference being given to 1,6-hexanediol bis[3-(3,5-di-tert-butyl-4-hydroxyphenyl)propionate] [CAS No. 35074-77-2] (Irganox® 259 from BASF SE, Ludwigshafen, Germany), pentaerythritol tetrakis[3-(3,5-di-tert-butyl-4-hydroxyphenyl)propionate] [CAS No. 6683-19-8] (Irganox® 1010 from BASF SE) and 3,9-bis[2-[3-(3-tert-butyl-4-hydroxy-5-methylphenyl)propionyloxy]-1,1-dimethylethyl]-2,4,8,10-tetraoxaspiro[5.5]undecanes [CAS No. 90498-90-1] (ADK Stab® AO 80). ADK Stab® AO 80 is commercially available from Adeka-Palmerole SAS, Mulhouse, France.

Among the aliphatically or aromatically substituted phosphites for use, preference is given to bis(2,4-dicumylphenyl)pentaerythritol diphosphite [CAS No. 154862-43-8], which is available for example from Dover Chemical Corp., Dover, USA under the trade name Doverphos® S9228, and tetrakis(2,4-di-tert-butylphenyl)-1,1-biphenyl-4,4′-diyl bisphosphonite [CAS No. 38613-77-3], which can be obtained, for example, as Hostanox® P-EPQ from Clariant International Ltd., Muttenz, Switzerland.

Also employable as component K) to protect from basic hydrolysis are inorganic phosphate salts from the group of metal hydrogen phosphates, metal dihydrogen phosphates, metal dihydrogen pyrophosphates and/or metal pyrophosphates, wherein metal here stands for sodium, potassium, magnesium, calcium, zinc, copper and/or aluminium. The corresponding hydrates are also included here according to the invention. It is preferable here to employ inorganic phosphate salts having a pH in the range from 2 to 6, particularly preferably in the range from 2 to 4, the reported values for pH being based here on aqueous medium at 20° C. and a concentration of 1 g per litre. Preferably employed from the group of metal dihydrogen pyrophosphates and metal pyrophosphates are sodium dihydrogenpyrophosphate [CAS No. 7758-16-9], calcium dihydrogenpyrophosphate [CAS No. 14866-19-4], magnesium pyrophosphate [CAS No. 13446-24-7], calcium pyrophosphate [CAS No. 7790-76-3] and zinc pyrophosphate [CAS No. 7446-26-6]. Preferably employed from the group of metal hydrogenphosphates are calcium hydrogenphosphate [CAS No. 7757-93-9], calcium hydrogenphosphate dihydrate [CAS No.7789-77-7], magnesium hydrogenphosphate [CAS No. 7757-86-0] and zinc hydrogenphosphate [CAS No.7664-38-2]. From the group of metal dihydrogenphosphates especially preferred for use it is preferable to employ aluminium dihydrogenphosphate [CAS No. 13530-50-2], magnesium bis(dihydrogenphosphate) [CAS No.13092-66-5], calcium bis(dihydrogenphosphate) [CAS No. 7758-23-8], zinc bis(dihydrogenphosphates) [CAS No.13598-37-3] and zinc bis(dihydrogenphosphate) dihydrate [CAS No. 13986-21-5].

Nucleating agents preferred for use as component K) are sodium or calcium phenylphosphinate, aluminium oxide, silicon dioxide or talc [CAS No.14807-96-6], preference being given to talc. It is particularly preferable to employ microcrystalline talc. Talc is a sheet silicate having the chemical composition Mg₃[Si₄O₁₀(OH)₂], which, depending on the modification, crystallizes as talc-1A in the triclinic crystal system or as talc-2M in the monoclinic crystal system (http://de.wikipedia.org/wiki/Talkum). Talc [CAS No. 14807-96-6] for use in accordance with the invention is commercially available, for example, under the name Mistron® R10 from Imerys Talc Group, Toulouse, France (Rio Tinto Group).

Anti-drip agents preferred for use as component K) are in particular tetrafluoroethylene polymers. The tetrafluoroethylene polymers may be employed in pure form or else in combination with other resins, preferably styrene-acrylonitrile (SAN), or acrylates, preferably methyl methacrylate and/or butyl acrylate. An especially preferably suitable example of tetrafluoroethylene-styrene-acrylonitrile resins is, for example, Cycolac® INP 449 [CAS No. 1427364-85-9] from Sabic Corp., Riyadh, Saudi Arabia; an especially preferably suitable example of tetrafluoroethylene-acrylate resins is, for example, Metablen A3800 [CAS No. 639808-21-2] from Mitsubishi Rayon Co., Ltd., Tokyo, Japan. Anti-drip agents comprising tetrafluoroethylene polymers are used in accordance with the invention as component K) preferably in amounts in the range from 0.01 to 5 parts by mass, particularly preferably in the range from 0.05 to 2 parts by mass, based in each case on 100 parts by mass of component A).

If required for the application halogen-containing flame retardants may also be employed as component K). These include commercially available organic halogen compounds with or without synergists. Halogenated, in particular brominated and chlorinated, compounds preferably include ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene and brominated polyphenylene ethers.

Suitable synergists preferably include antimony compounds, especially antimony trioxide and antimony pentoxide, zinc compounds, tin compounds, especially zinc stannate, and borates, especially zinc borates.

In a preferred embodiment the present invention relates to compositions and moulding compounds and articles of manufacture producible therefrom comprising A) polybutylene terepthalate, B) polyethylene terepthalate, C) aluminium tris(diethylphosphinate), D) melem and E) melamine polyphosphate.

In a preferred embodiment the present invention further relates to compositions and moulding compounds and articles of manufacture producible therefrom comprising A) polybutylene terephthalate, B) polyethylene terepthalate, C) aluminium tris(diethylphosphinate), D) melem, E) melamine polyphosphate and F) cyclic phenoxyphosphazene.

In a preferred embodiment the present invention further relates to compositions and moulding compounds and articles of manufacture producible therefrom comprising A) polybutylene terephthalate, B) polyethylene terepthalate, C) aluminium tris(diethylphosphinate), D) melem, E) melamine polyphosphate and F) cyclic phenoxyphosphazene and G) barium sulfate.

In a preferred embodiment, the present invention further relates to compositions and moulding compounds and articles of manufacture producible therefrom comprising A) polybutylene terephthalate, B) polyethylene terepthalate, C) aluminium tris(diethylphosphinate), D) melem, E) melamine polyphosphate and F) cyclic phenoxyphosphazene, G) barium sulfate and H) glass fibres, preferably glass fibres made of E glass, particularly preferably glass fibres having a mean fibre diameter in the range of 10 to 12 μm and/or having a mean fibre length of 4.5 mm.

Use

The present invention, however, also relates to the use of the compositions according to the invention, in particular in the form of moulding compounds, for producing flame retardant articles of manufacture, preferably electrical or electronic assemblies and components.

The present invention, however, also relates to the use of the compositions according to the invention, in particular having high thermal stability to transesterification and high flame retardancy according to tests to UL94 and IEC 60695-2-13, for producing electricals or electronics industry articles of manufacture, in particular electricals or electronics industry articles of manufacture in domestic appliances, wherein in addition to polyethylene terephthalate at least one further polyalkylene terephthalate and/or a polycycloalkylene terephthalate, in particular at least polybutylene terephthalate, is employed as the polyester.

Method

The present invention, however, also relates to a method for producing articles of manufacture, preferably for the electrical or electronics industry, particularly preferably electronic or electrical assemblies and components, by mixing compositions according to the invention to form a moulding compound. These moulding compounds may additionally be discharged in the form of a strand, cooled until pelletizable and pelletized, before being subjected as a matrix material to injection moulding or extrusion, preferably injection moulding.

The invention accordingly relates to a method for producing articles of manufacture in which compositions according to the invention are mixed to afford moulding compounds, said moulding compounds are discharged in the form of a strand, cooled until pelletizable and pelletized and subjected as a matrix material to an injection moulding or extrusion operation.

Mixing is preferably performed at temperatures in the range from 240 to 310° C., preferably in the range from 260 to 300° C., particularly preferably in the range from 270 to 295° C., in the melt. Especially preferably, a twin-shaft extruder is used for this purpose.

In one embodiment, the pellet material comprising the composition according to the invention is dried, preferably at temperatures in the range around 120° C. in a vacuum drying cabinet or in a dry air drier, for a duration in the region of 2 hours, before being subjected as matrix material to injection moulding or an extrusion process in order to produce articles of manufacture according to the invention.

The present invention, however, also relates to a method of improving the tracking resistance of polyester-based articles of manufacture by processing inventive compositions in the form of moulding compounds as a matrix material by injection moulding or extrusion.

The methods of injection moulding and of extrusion of thermoplastic moulding compounds are known to those skilled in the art.

Methods according to the invention for producing polyester-based articles of manufacture by extrusion or injection moulding operate at melt temperatures in the range from 240° C. to 330° C., preferably in the range from 260° C. to 300° C., particularly preferably in the range from 270° C. to 290° C., and optionally, in addition, at pressures of not more than 2500 bar, preferably at pressures of not more than 2000 bar, particularly preferably at pressures of not more than 1500 bar and very particularly preferably at pressures of not more than 750 bar.

Sequential coextrusion involves expelling two different materials successively in alternating sequence. In this way, a preform having a different material composition section by section in the extrusion direction is formed. It is possible to endow particular article sections with specifically required properties through appropriate material selection, for example for articles with soft ends and a hard middle section or integrated soft bellows regions (Thielen, Hartwig, Gust, “Blasformen von Kunststoffhohlkörpern” [Blow-Moulding of Hollow Plastics Bodies], Carl Hanser Verlag, Munich 2006, pages 127-129).

In the method of injection moulding, a moulding compound comprising the compositions according to the invention, preferably in pellet form, is melted in a heated cylindrical cavity (i.e. plasticated) and injected under pressure into a temperature-controlled cavity as an injection moulding compound. After cooling (solidification) of the material, the injection moulding is demoulded.

The following operations are distinguished:

1. plastication/melting

2. injection phase (filling operation)

3. hold pressure phase (because of thermal contraction during crystallization)

4. demoulding.

In this regard, see http://de.wikipedia.org/wiki/Spritzgie%C3%9Fen. An injection moulding machine comprises a closure unit, the injection unit, the drive and the control system. The closure unit includes fixed and movable platens for the mould, an end platen, and tie bars and drive for the movable mould platen (toggle joint or hydraulic closure unit).

An injection unit comprises the electrically heatable barrel, the drive for the screw (motor, transmission) and the hydraulics for moving the screw and the injection unit. The injection unit serves to melt, meter, inject and exert hold pressure (because of contraction) on the powder/the pellet material. The problem of melt backflow inside the screw (leakage flow) is solved by nonreturn valves.

In the injection mould, the incoming melt is then separated and cooled and the article of manufacture to be fabricated is thus fabricated. Two halves of the mould are always required therefor. In injection moulding, the following functional systems are distinguished:
runner system
shaping inserts
venting
machine mounting and force absorption
demoulding system and motion transmission
temperature control

In contrast to injection moulding, in extrusion an endless plastics extrudate of an inventive moulding compound is employed in an extruder, the extruder being a machine for producing shaped thermoplastic mouldings. Reference is made here to http://de.wikipedia.org/wiki/Extrusionsblasformen. A distinction is made between single-screw extruders and twin-screw extruders, and also between the respective subgroups of conventional single-screw extruders, conveying single-screw extruders, contrarotating twin-screw extruders and corotating twin-screw extruders.

Extrusion plants are composed of the elements extruder, mould, downstream equipment, extrusion blow moulds. Extrusion plants for producing profiles are composed of the elements: extruder, profile mould, calibrating unit, cooling zone, caterpillar take-off and roller take-off, separating device and tilting chute.

The present invention, accordingly, also relates to articles of manufacture, especially tracking-resistant articles of manufacture, obtainable by extrusion, preferably profile extrusion, or injection moulding of the moulding compounds obtainable from the compositions of the invention.

### EXAMPLES

In order to demonstrate the improvements in tracking resistance and mechanical properties described in accordance with the invention, corresponding polyester moulding compounds were first of all made up by compounding. To this end, the individual components were mixed in a twin-screw extruder (ZSK 26 Mega Compounder from Coperion Werner & Pfleiderer (Stuttgart, Germany)) at temperatures in the range from 260 to 300° C., discharged as a strand, cooled until pelletizable and pelletized. After drying (generally 2 hours at 120° C. in a vacuum drying cabinet), the pellet material was processed into test specimens.

The test specimens for the investigations reported in Table 1 were injection-moulded on an Arburg 320-210-500 injection moulding machine at a melt temperature of 260° C. and a mould temperature of 80° C.:

test specimens for glow wire testing based on DIN EN 60695-2-13

Glow wire resistance was determined on the basis of the GWIT (Glow Wire Ignition Temperature) test according to DIN EN 60695-2-13. In the GWIT test, the figure reported is the glow wire ignition temperature which is 25K (or 30K in the case of temperatures in the range from 900° C. to 960° C.) higher than the maximum glow wire temperature which fails to result in ignition in three successive tests, even during the time of exposure to the glow wire. Ignition here is taken to be a flame with a burn time 5 seconds. The tests employed round plaques having a diameter of 80 mm and a thickness of 0.75 mm. Not only the glow wire ignition temperature but also the burn time of the flame at a glow wire temperature of 800° C. is reported. A burn time of 0 seconds indicates that the sample did not undergo ignition at all, i.e. no flame having a burn time of greater than 0 seconds and less than 5 seconds was observed either.

The thermal stability toward transesterification of component A) and component B) was determined on the pellet material using the DSC method (differential scanning calorimetry [https://de.wikipedia.org/wiki/Dynamische Differenzkalorimetrie]) on a Mettler DSC 822e instrument from Mettler Toledo, Greifensee, Switzerland. To this end, 10(±2) mg of the respective composition processed into a compound were weighed in and then heated from 0° C. to 280° C. at +20K/min under nitrogen [“1st heating”], then cooled from 280° C. back down to 0° C. at −10K/min and finally heated from 0° C. to 280° C. again at +20K/min [“2nd heating”]. In accordance with the elucidation hereinabove the shift in the melting peak between the 1st heating and the 2nd heating may be regarded as a measure of transesterification and thus as a measure of the thermal stability of the sample.

In the examples the difference in melting temperature between the 1st heating and the 2nd heating in each case determined from the melting peak of the higher melting base resin is therefore regarded as a measure of the transesterification of the polyester components, wherein a shift of less than or equal to 10° C. represents a low propensity for transesterification while a shift of more than 10° C. represents a high degree of transesterification and thus low thermal stability.

Reactants

Component A): Linear polybutylene terephthalate (Pocan® B 1300, commercially available product of Lanxess Deutschland GmbH, Leverkusen, Germany) having an intrinsic viscosity of 93 cm³/g (measured in phenol: 1,2-dichlorobenzene =1:1 at 25° C.). The melting point determined as the melting peak for the 1st heating according to the abovementioned DSC method was 222° C.

Component B): PET, Lighter® C93 from Equipolymers Global GmbH (Horgen, Switzerland); PET-Copolymer having an isophthalic acid content of about 1-3%. The melting point determined as the melting peak for the 1st heating according to the abovementioned DSC method was 252° C.

Component C): Aluminium tris(diethylphosphinate), [CAS No. 225789-38-8] (Exolit® OP1230 from Clariant SE, Muttenz, Switzerland)

Component D): Melem [CAS No. 1502-47-2] having a melamine content of <1% (Delacal NFR from Delamin Ltd., Derby, UK)

Component E) Melamine polyphosphate [CAS No. 218768-84-4] (Melapur® 200/70 from BASF, Ludwigshafen, Germany)

Component F) Phenoxyphosphazenes (Rabitle® FP110 [CAS No. 1203646-63-2] from Fushimi Pharmaceutical Co. Ltd, Kagawa

Component G) Barium sulfate [CAS No.7727-43-7] (BLANC FIXE Super F from Sachtleben Chemie GmbH, Duisburg, Germany)

Component H): Glass fibre sized with silane-containing compounds and having a diameter of 10 μm (CS 7967, commercially available product from Lanxess N.V., Antwerp, Belgium)

Further component K) additives used in the examples were, as component K/1), the following components commonly used in flame-retardant thermoplastic polyesters:

Mould-release agent: pentaerythrityl tetrastearate (PETS) [CAS No. 115-83-3] (Loxiol® VPG 861, from Cognis Deutschland GmbH, Dusseldorf, Germany)

Heat stabilizer: tetrakis(2,4-di-tert-butylphenyl)-1,1-biphenyl-4,4′-diyIbisphosphonite [CAS No. 38613-77-3] (Hostanox® P-EPQ from Clariant International Ltd., Muttenz, Switzerland)

Anti-drip agent: Polytetrafluoroethylene, [CAS No. 9002-84-0] (Dyneon® PA 5932 from Dyneon GmbH & Co KG, Neuss, Germany)

Nucleating agent: Talc [CAS No. 14807-96-6]

The nature and amount of the further additives used (component K/1) are in each case the same for corresponding comparative examples and inventive examples.

TABLE 1

| | | Ex. 1 | Comp. 1 | Ex. 2 | Comp. 2 | Comp. 3 |
|---|---|---|---|---|---|---|
| Component A/1 | [parts by mass] | 100.0 | 100.0 | 100.0 | 100.0 | 100.0 |
| Component B/1 | [parts by mass] | 83.2 | 83.2 | 87.2 | 87.2 | 87.2 |
| Component C/1 | [parts by mass] | 33.6 | 38.7 | 32.4 | 39.4 | 48.2 |
| Component D/1 | [parts by mass] | 21.7 | 21.7 | 10.5 | 0.0 | 0.0 |
| Component E/1 | [parts by mass] | 9.4 | 0.0 | 9.1 | 10.8 | 0.0 |
| Component F/1 | [parts by mass] | 7.6 | 11.9 | 7.3 | 9.1 | 11.2 |
| Component G/1 | [parts by mass] | 7.2 | 7.2 | 7.0 | 7.0 | 7.0 |
| Component H/1 | [parts by mass] | 90.4 | 90.4 | 87.2 | 87.2 | 87.2 |
| Component I/1 | [parts by mass] | 8.5 | 8.5 | 8.2 | 8.2 | 8.2 |
| GWIT [0.75 mm] | [° C.] | ≥825 | ≥825 | ≥825 | 800 | 775 |
| Burn time at 800° C. glow wire | [s] | 0 | 0 | 0 | >5 | >5 |
| temperature [0.75 mm plaque] | | | | | | |
| DSC: Melting point 1st heating | [° C.] | 252 | 245 | 252 | 251 | 251 |
| DSC: Melting point 2nd heating | [° C.] | 245 | 228 | 251 | 243 | 238 |
| DSC: Melting point difference: | [° C.] | <10 | >10 | <10 | <10 | >10 |
| 1st heating − 2nd heating | | | | | | |

Examples 1 and 2 show that a GWIT of at least 825° C. coupled with high thermal stability towards transesterification can be achieved only when using an inventive combination comprising component D) and component E). If at least one of the two components D) and/or E) is missing this results in amplified transesterification of components A) and B) with one another (Comp. 1 and Comp. 2) and/or increased ignitability in the glow wire test according to IEC60695-2-13 (Comp. 2 and Comp. 3).

For better comparability of glow wire ignitability the sum of the fractions of components C), D), E) and F) in Ex. 1 and Comp. 1 and Ex. 2, Comp.2 and Comp. 3 respectively were kept constant.

1. A composition comprising:
A) at least one polyalkylene terephthalate distinct from polyethylene terephthalate, or polycycloalkylene terephthalate,
B) polyethylene terephthalate,
C) at least one organic phosphinic salt of formula (I) and/or at least one organic diphosphinic salt of formula (II) and/or polymers thereof, 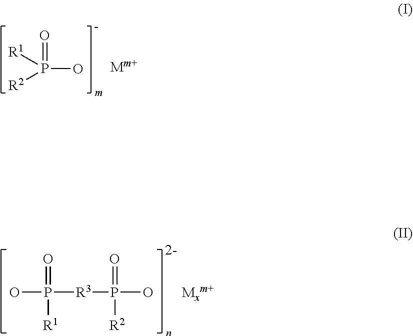
in which
R¹, R² are identical or different and stand for a linear or branched C₁-C₆-alkyl and/or for C₆-C₁₄-aryl,
R³ stands for linear or branched C₁-C₁₀alkylene, C₆-C₁₀arylene or for C₁-C₆-alkyl-C₆-C-₁₀-arylene, or C₆-C₁₀-aryl-C₁-C₆alkylene,
M is aluminium, zinc or titanium,
m is an integer of 1 to 4;
n is an integer of 1 to 3, and
x is 1 or 2,
wherein n, x and m in formula (II) may at the same time adopt only integer values such that the diphosphinic salt of formula (II) as a whole is uncharged,
D) at least one condensed melamine derivative, and
E) at least one reaction product of a melamine derivative with phosphoric adds or condensed phosphoric adds.

2. The composition according to claim 1, wherein the composition comprises, based on 100 parts by mass of component A),
25 to 120 parts by mass of component B),
20 to 80 parts by mass of component C),
2 to 40 parts by mass of component 14, and
2-30 parts by mass of component E).

3. The composition according to claim 1, further comprising at least one of:
F) at least one further flame retardant distinct from components C), D) and E);
G) at least one metal sulfate: and
H) at least one filler or reinforcer distinct from components A) to G).

4. The composition according to claim 2, further comprising, based on 100 parts by mass of component A), at least one of:
F) 2 to 50 parts by mass of at least one further flame retardant distinct from components C), D and E);
G) 1 to 40 parts by mass of at least one metal sulfate; and
H) 0.1 to 300 parts by mass of at least one filler or reinforcer distinct from components A to G).

5. The composition according to claim 2, further comprising, based on 100 parts by mass of component A):
F) 2 to 50 parts by mass of at least one further flame retardant distinant from components C), D) and E);
G) 1 to 4 parts by mass of at least one meta sulfate; and
H) 0.1 to 300 party by mass of at least one filler or reinforcer distinct from components A) to G).

6. The composition according to claim 1, wherein component D) comprises at least one of melam, melem, and melon.

7. The composition according to claim 1, wherein component E) comprises at least one of dimelamine phosphate, dimelamine pyrophosphate, melamine phosphate, melamine pyrophosphate, melamine polyphosphate, melam polyphosphate, melon polyphosphate, and melem polyphosphate.

8. The composition according to claim 3, wherein:
the at least one further flame retardant is halogen-free;
the at least one metal sulfate comprises at least one of magnesium sulfate, calcium sulfate, barium sulfate, and zinc sulfate; and
the at least one filler or reinforcer is selected from the group consisting of mica, silicate, quartz, titanium dioxide, wollastonite, nepheline syenite, kaolin, amorphous silicas, magnesium carbonate, chalk, feldsper, glass fibres, glass beads, glass flour, fibrous fillers, and reinforcers based on carbon fibres.

9. The composition according to claim 8, wherein the at least one metal sulfate is barium sulfate.

10. The composition according to claim 5, wherein:
the at least one further flame retardant is halogen-free;
the at least one metal sulfate comprises at least one of magnesium sulfate, calcium sulfate barium sulfate, and zinc sulfate: and
at least one filler or reinforcer is selected from the group consisting of mica, silicate, quartz flour, titanium dioxide, wollastonite, nepheline syenite, kaolin, amorphous silicas, magnesium carbonate, chalk, feldspar, glass fibres, glass beads, glass flour, and fibrous fillers, and reinforcers based on carbon fibres.

11. The composition according to claim 10, wherein the least one filler or reinforcer comprises chopped long glass fibres having an initial length of 1 to 50 mm.

12. The composition according to claim 1, wherein:
A) is polybutylene terephthalate,
B) is polyethylene terephthalate.
C) is aluminium tris(diethylphosphinate),
D) is melem, and
E) is melamine polyphosphate.

13. The composition according to claim 3,wherein the composition includes F) wherein:
A) is polybutylene terephthalate,
B) is polyethylene terephthalate,
C) is aluminium tris(diethylphosphinate),
D) is melem,
E) is melamine polyphosphate, and
F) cyclic phenoxyphosphazene.

14. The composition according to claim 11, wherein:
A) is polybutylene terephthalate,
B) is polyethylene terephthalate,
C) is aluminium tris(diethylphosphinate),
D) is melem,
E) is melamine polyphosphate, and
F) is cyclic phenoxyphosphazene, and
G) is barium sulfate.

15. A method for producing articles of manufacture, the method comprising mixing compositions according to claim 1 to afford moulding compounds, discharging the moulding compounds in the form of a strand, cooling the strands until pelletizable, pelletizing the cooled strands into pellets, and subjecting the pellets as a matrix material to an injection moulding or extrusion operation to form an article of manufacture.

16. The method according to claim 15 wherein article of manufacture is a flame retardant article of manufacture, and the method is a method for producing flame retardant articles of manufacture.

17. The method of claim 16 wherein the flame retardant article of manufacture comprises an electrical component.

18. An article of manufacture comprising the composition according to claim 1.

19. The article of manufacture according to claim 18, wherein the article of manufacture is an electrical component.
